(19) United States
(12) Patent Application Publication
(10) Pub. No.: US 2025/0111847 A1
(43) Pub. Date: Apr. 3, 2025

(54) Long Running Language Model Thread Truncation

(71) Applicant: International Business Machines Corporation, Armonk, NY (US)

(72) Inventors: Zachary A. Silverstein, Georgetown, TX (US); Logan Bailey, Atlanta, GA (US); Mu Qiao, Belmont, CA (US); Jeremy R. Fox, Georgetown, TX (US)

(21) Appl. No.: 18/375,832

(22) Filed: Oct. 2, 2023

(51) Int. Cl. G10L 15/183; G10L 15/06

(52) U.S. Cl. CPC G10L 15/183; G10L 15/063; G10L 2015/0631; G10L 2015/0638

(57) ABSTRACT

Techniques for truncating long running language model conversation threads are provided. In one aspect, a language model thread truncation system includes: a language model; and a thread truncation module configured to obtain prompts and responses from a thread of user interactions with the language model during a conversation, cluster the prompts and responses based on their topical representation to create a cluster around a topic, and after a timing threshold has been reached, truncate the thread by removing the cluster from the thread if the current topic of the conversation differs from the topic of the cluster and if a reference value of the cluster is below a minimum value, otherwise retain the cluster in the thread. The reference value of the cluster can be determined based on individual reference scores for the prompts and responses in the cluster. A method for language model thread truncation is also provided.

### FIELD OF THE INVENTION

The present invention relates to language model conversation thread processing, and more particularly, to techniques for truncating long running language model conversation threads in order to bound context growth in an intelligent manner.

### BACKGROUND OF THE INVENTION

Natural language processing enables computers to understand human language as it is spoken and written. Through deep learning, large language models provide the foundation for natural language processing. As its name implies, a large language model is characterized by its large size, potentially containing tens of millions to even billions of parameters.

For instance, large language models provide human-computer interaction manners for a user to engage with a conversation bot. A conversation bot is a computer program that uses artificial intelligence and natural language processing to understand questions from a user and automate responses to them, simulating human conversation. Through these interactions, the conversation bot can take the context of previously processed data and previously exchanged communications with the user to help set the tone and other components of future responses.

However, by this process, the large language model conversation bot interactions become increasingly harder to follow as the conversation continues to build and build upon itself. As a result of this context growth, the user might become inundated with topics no longer relevant to the current conversation.

### SUMMARY OF THE INVENTION

The present invention provides techniques for truncating long running language model conversation threads in order to bound context growth in an intelligent manner. In one aspect of the invention, a language model thread truncation system is provided. The language model thread truncation system includes: a language model; and a thread truncation module configured to obtain prompts and responses from a thread of user interactions with the language model during a conversation, cluster the prompts and responses based on their topical representation to create a cluster around a topic, and after a timing threshold for the cluster has been reached, truncate the thread by removing the cluster from the thread if the current topic of the conversation differs from the topic of the cluster and if a reference value of the cluster is below a minimum value, otherwise retain the cluster in the thread.

Advantageously, truncating threads in this manner serves to bound context growth thereby making the interactions easier for the user to follow, even as the conversation continues to build upon itself and a range of different topics is discussed. This truncation is done in an intelligent manner to better focus on the topics that are relevant to the current conversation and are of interest to the user, and those that the user has recently made reference to. Conversely, older topics no longer being talked about, or those that the user no longer wishes to discuss can be selected for removal from the thread.

The timing threshold can be based on the passage of more than a certain amount of time since the cluster was created. It can also be based on the exchange of more than a certain number of messages (prompts and responses) since that cluster was created. A combination of these timing criteria may also be employed based, for example, on the passage of more than a certain amount of time or the exchange of more than a certain number of messages, whichever occurs first.

In another aspect of the invention, another language model thread truncation system is provided. The language model thread truncation system includes: a language model; and a thread truncation module configured to obtain prompts and responses from a thread of user interactions with the language model during a conversation, cluster the prompts and responses based on their topical representation to create a cluster around a topic, generate individual reference scores for the prompts and responses in the cluster, where the individual reference scores represent a last time the conversation has comes back to information contained in the prompts and responses, and after a timing threshold for the cluster has been reached, truncate the thread by removing the cluster from the thread if the current topic of the conversation differs from the topic of the cluster and if a reference value of the cluster is below a minimum reference value, otherwise retain the cluster in the thread, where the reference value of the cluster is determined based on the individual reference scores for the prompts and responses in the cluster.

For instance, the reference value of the cluster can be determined as an average value of the individual reference scores for the prompts and responses in the cluster. Alternatively, a highest reference score value amongst the individual reference scores for the prompts and responses in the cluster can be used as the reference value of the cluster.

In yet another aspect of the invention, a method for language model thread truncation is provided. The method includes: obtaining prompts and responses from a thread of user interactions with a language model during a conversation; clustering the prompts and responses based on their topical representation to create a cluster around a topic; generating individual reference scores for the prompts and responses in the cluster, where the reference scores represent a last time the conversation has come back to information contained in the prompts and responses; and after a timing threshold for the cluster has been reached, truncating the thread by removing the cluster from the thread if the current topic of the conversation differs from the topic of the cluster and if a reference value of the cluster is below a minimum value, otherwise retaining the cluster in the thread, where the reference value of the cluster is determined based on the individual reference scores for the prompts and responses in the cluster.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary computing environment according to an embodiment of the present invention;

FIG. 2 is a diagram illustrating an exemplary language model thread truncation system according to an embodiment of the present invention;

FIG. 3 is a diagram illustrating an exemplary neural network according to an embodiment of the present invention;

FIG. 4 is a diagram illustrating an exemplary methodology for language model thread truncation according to an embodiment of the present invention;

FIG. 5 is a diagram illustrating an example of cosine similarity between two vectors according to an embodiment of the present invention; and

FIG. 6 is a diagram illustrating an example of thread truncation according to an embodiment of the present invention.

### DETAILED DESCRIPTION OF PREFERRED EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

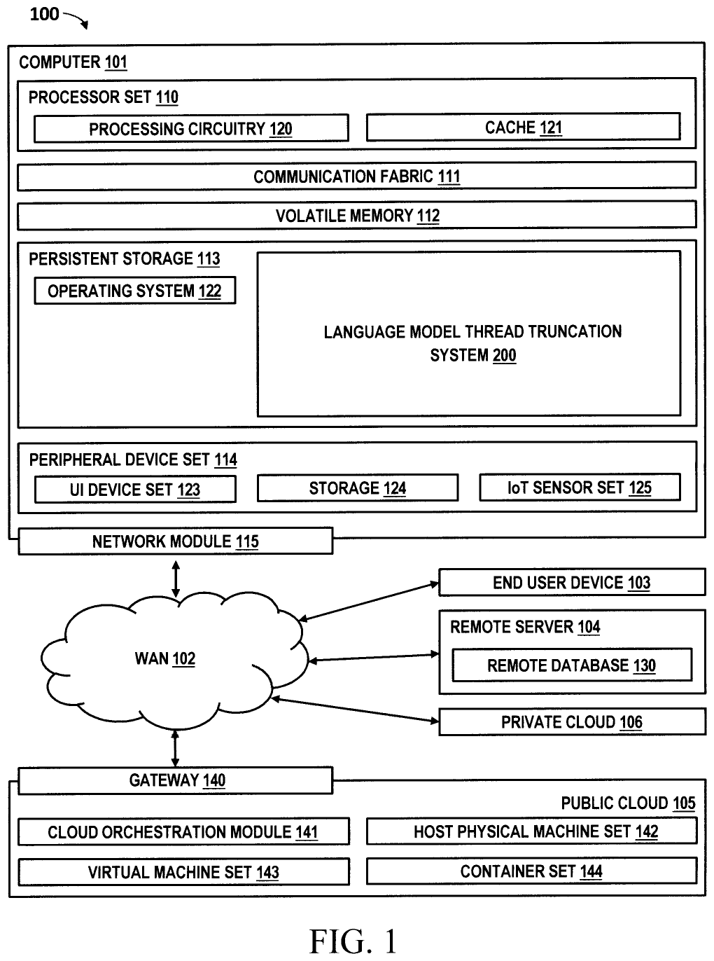

Referring to FIG. 1, computing environment 100 contains an example of an environment for the execution of at least some of the computer code involved in performing the inventive methods, such as language model thread truncation system 200. In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in system 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Natural conversation style human-computer interactions can leverage large language models to generate responses to user prompts. These language model-based conversational artificial intelligence engines are also referred to herein generally as ‘conversation bots.’ A user can prompt the conversation bot with queries on different topics and receive responses related to the queries. User prompts and conversation bot responses may also be referred to herein generally as ‘conversation messages’ or simply ‘messages.’ These conversations (i.e., prompts and responses) are often threaded. Namely, the prompts and responses in a given conversation are grouped together in what is referred to herein as a ‘conversation thread’ or simply a ‘thread.’ For instance, a thread may contain a prompt A, a response to prompt A, a prompt B, a response to prompt B, and so on. Thus, a thread builds as the conversation progresses.

However, as highlighted above, as the conversation continues to build and build upon itself and a range of different topics are discussed, the interactions can become harder for a user to follow. For instance, as the conversation shifts from one topic to another, threads may build up prompts and responses related to topics that are no longer relevant to the current discussion. For example, the user might begin the conversation with a prompt about a first topic (Topic A), but then quickly move on to a second topic (Topic B). If Topic A does not come up again in the conversation, it is likely no longer of interest to the user. However, with conventional approaches, discussions related to older topics remain in the thread. This can occur over and over during the course of a conversation, inundating the user with exchanges the user is no longer interested in.

As will be described in detail below, the present techniques leverage the context (or setting) in which the various thread prompts and responses are made during a conversation as they relate to the topics being discussed. Namely, over the course of a conversation, the prompts and responses in a thread will be clustered based on their topical representation, i.e., association with a particular topic, for example, prompts and responses related to Topic A are placed in one cluster, prompts and responses related to Topic B are placed in another cluster, and so on. Threads grow contextually as the conversation progresses and more topics are discussed (e.g., prompts and responses related to newly discussed Topic C are added to the thread). This is referred to herein as ‘context growth.’

Advantageously, the present techniques can be employed to bound such context growth in an intelligent manner whereby threads are truncated to remove previous contexts (namely prompts and responses related to older topics) from threads that are no longer being referenced, and thus no longer relevant to the current discussion. As will be described in detail below, a timing threshold (such as the passage of more than a certain amount of time and/or the exchange of more than a certain number of messages (i.e., prompts and responses)) can be used in making this determination. The notion is that, after a threshold amount of time and/or number of messages exchanged has elapsed, if a topic has not been brought up again (i.e., referenced) in the conversation then it is a candidate for removal from the thread during truncation. Threads discussing topics that have not been referenced in more than the threshold amount of time and/or number of messages are also referred to herein as ‘long-running threads.’

However, as will also be described in detail below, an additional forgetting parameter can also optionally be implemented which impacts (i.e., elevates or lowers) the value of a given topic. Further, this forgetting parameter is autonomously assigned, meaning that rather than having the user actively set the parameter for a topic the present system 200 monitors the conversation for keywords and/or phrases that indicate user preference regarding a topic. For instance, when discussing Topic A if the user prompt includes “I want to discuss Topic A again later,” then the forgetting parameter for Topic A can be decreased meaning that Topic A is less likely to be removed during thread truncation. Conversely, when discussing Topic A if the user prompt instead includes “I am tired of discussing Topic A,” then then the forgetting parameter for Topic A can be increased meaning that Topic A is more likely to be removed during thread truncation.

Advantageously, the present techniques leverage the ‘contextual memory’ present in conversation bot human-computer interactions. Namely, these conversations generally involve a user interacting with the present system 200 (via an interface 206—see below) in the form of one or more threads. Each of these threads may be thought of in terms of the individual contexts (i.e., topics) discussed therein. Specifically, everything that is said about a topic (by way of prompts and responses) stays within its given thread. Thus, each thread has a contextual memory that it works off of. While multiple topics may be discussed within a single thread, the prompts and responses related to each of those topics remain contained within the thread.

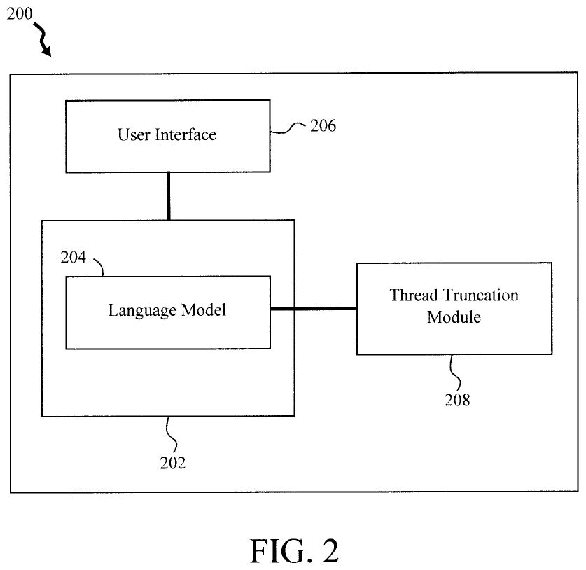

FIG. 2 is a diagram illustrating an exemplary configuration of system 200. As shown in FIG. 2, system 200 includes a conversation bot 202 that has as its artificial intelligence engine a language model 204, a user interface 206 through which users interact with the language model 204, and a thread truncation module 208 which applies the present approach to truncate long-running threads in conversations in order to intelligently bound context growth.

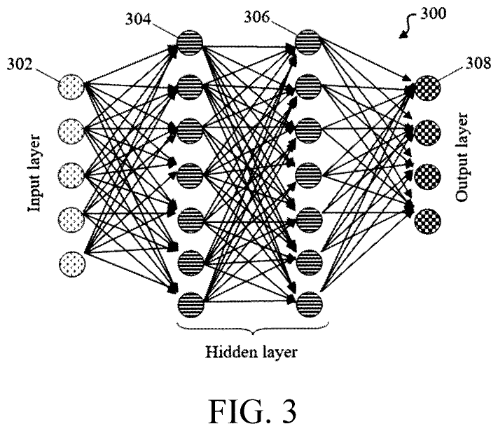

Language model 204 generally represents any type of machine learning model for use in natural language processing. According to one exemplary embodiment, language model 204 is a large language model. As its name implies, a large language model is characterized by its large size, potentially containing tens of millions to even billions of parameters (i.e., weights). One category of large language models that may be used in accordance with the present techniques is a transformer model. In general, a transformer model is a neural network that learns context and meaning by tracking relationships in sequential data, such as the sequence of words in a sentence. Referring briefly to FIG. 3, a general fully-connected feed-forward neural network 300 is provided. As shown in FIG. 3, neural network 300 includes a plurality of interconnected processor elements 302, 304/306 and 308 that form an input layer, at least one hidden layer, and an output layer, respectively, of the neural network 300. The connections in neural networks that carry electronic messages between simulated neurons are provided with numeric weights that correspond to the strength or weakness of a given connection. These numeric weights can be adjusted and tuned based on experience, making neural networks adaptive to inputs and capable of learning. Typically, neural networks are trained on labeled sets of training data. Once trained, the neural network can be used for inference. Inference applies knowledge from a trained neural network model and uses it to infer a result. A fully connected layer (typically the last or last few layers in a neural network) is a layer where all of the inputs from one layer are connected to every activation unit of the next layer. The fully connected layer(s) compile the data extracted by previous layers of the neural network to form the final output.

As will be described in detail below, thread truncation module 208 obtains the user prompts and corresponding responses from the language model 204 and maps them to a topic. If or when the topics being discussed diverge, the thread truncation module 208 will remove the previous contexts (prompts and responses related to older topics) from the thread. As highlighted above, a timing threshold (i.e., the passage of more than a certain amount of time and/or the exchange of more than a certain number of messages) can be used to identify older topics in long-running threads.

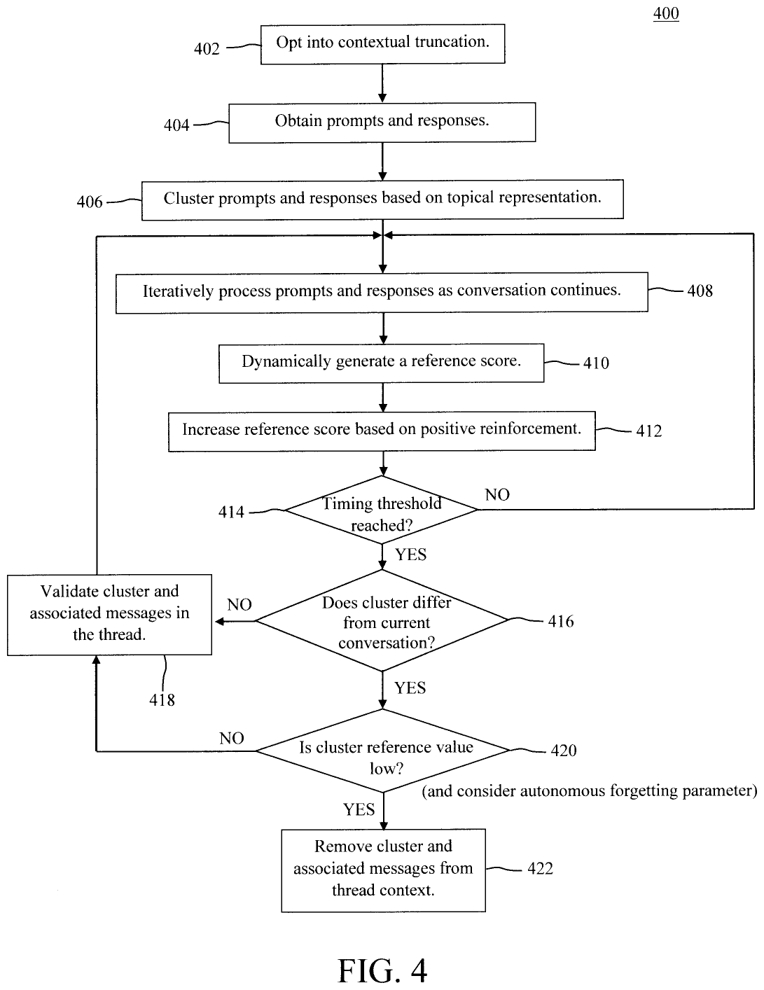

FIG. 4 is a diagram illustrating an exemplary methodology 400 for language model thread truncation. According to an exemplary embodiment, methodology 400 is performed by system 200 of FIG. 2. As highlighted above, the overall approach implemented by thread truncation module 208 is to contextualize the user prompts and responses by the language model 204 in a thread around the various topics discussed. As the thread diverges, thread truncation module 208 will remove the context related to older topics in order to truncate the thread.

Namely, in step 402, a user opts into the present contextual truncation feature. This will enable thread truncation module 208 to autotruncate long-running conversation threads as the user interacts with language model 204. As provided above, users can interact with language model 204 via interface 206, such as via a computer monitor or other display. Advantageously, by opting into contextual truncation, threads will be easier for the user to follow throughout the conversation, and these threads will be more meaningful for the user since they will be automatically and intelligently truncated to include only those topics most relevant to the current interests of the user.

In step 404, thread truncation module 208 obtains prompts and responses as the user interacts with language model 204. For instance, the user might prompt the language model 204 of conversation bot 202 with the query “What type of orange is good for making orange juice?” and the corresponding response from the language model 204 might be “Valencia oranges are very popular for making orange juice.” Data from this back-and-forth exchange is ingested by the thread truncation module 208.

As highlighted above, the context or setting in which the prompts and responses are made is leveraged to associate the prompts and responses with their related topics. This is done by grouping or clustering the prompts and responses by their topical representation (or in other words, by the topics they represent). See step 406. According to an exemplary embodiment, step 406 is performed by thread truncation module 208 using a metric such as cosine similarity and/or latent Dirichlet allocation.

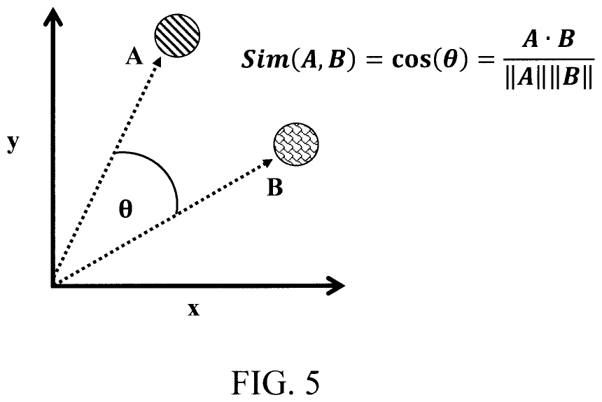

Language models represent words using (n-dimensional) vectors which are unique to each of the words in a text. As such, these vectors can be thought of as representing the meaning of individual words in the text. Cosine similarity looks at the similarity between two of these (non-zero) vectors defined in an inner product space. Cosine similarity is measured as the cosine of the angle between the two of the vectors, and determines whether the two vectors are pointing in approximately the same direction. The cosine similarity will range from 0 to 1, where a cosine similarity score of 1 means that the two vectors have the same orientation. Conversely, cosine similarity values closer to 0 indicate that the two vectors have less similarity. For instance, referring briefly to the graphic shown in FIG. 5, the similarity of a vector A and a vector B, i.e., Sim(A, B), can be measured as the cosine of the angle θ between them:

$$Sim ( A , B ) = cos ( θ ) = \frac{A \cdot B}{‖ A ‖ ‖ B ‖} .$$

Through cosine similarity, prompts and responses using the same or similar words will be grouped in the same cluster. By this process, each cluster will end up containing the prompts and responses related to a certain topic (the same topical representation). For instance, again using the example above, if all of the prompts and responses containing the words ‘Oranges,’ ‘Orange juice,’ etc. are grouped together, then the resulting cluster can represent the topic of Oranges as a food. If, however, the conversation then drifts to other topics such as towns in the U.S. named Orange, their location, climate, etc. then that may serve as the basis for another cluster around the topic of Orange as a location.

Another approach contemplated herein for clustering the prompts and responses is through a language topic modelling method such as Latent Dirichlet allocation. Latent Dirichlet allocation is a tool for statistical topic modelling. Latent Dirichlet allocation models documents as a mixture of topics, and each of those topics as a collection of words. Latent Dirichlet allocation operates through an iterative process whereby the words in the documents are each initially assigned to a topic. This assignment is then updated based on the probability of co-occurrence of a particular word with other words/topics and Dirichlet variability. This updating is performed for all of the words in all of the documents. The process is then repeated.

The above-described clustering process is performed in an iterative manner as new context is generated. Namely, as the conversation continues, new prompts and responses are obtained by the thread truncation module 208 and added to existing or new clusters based on their topical representation. See step 408. As above, this iterative clustering can be performed using a similarity metric such as cosine similarity, or a topic modelling approach like latent Dirichlet allocation.

In step 410, the thread truncation module 208 dynamically generates an individual reference score for the prompts and responses in each of the clusters. This reference score is a time-based metric representing the last time the conversation has come back to (i.e., referenced) information contained in the prompts and responses. This ‘comeback’ or reference to information can be on the part of the user and/or the language model 204. For instance, even if the conversation shifts to the topic of local businesses, the user might ask about which of these businesses sells Valencia oranges locally, i.e., a comeback or reference. Likewise, during a discussion of baking, also a different topic, the language model 204 might reference orange zest as an ingredient knowing that the user likes oranges.

According to an exemplary embodiment, the reference score is calculated using a weighted model where a value over time T is captured from 0 to 1. Namely, queries to the model are weighted to determine the relevance and usage of that content over time, whether that be T time in seconds or, more preferably, T time in queries. For instance, embodiments are contemplated herein where a weighted cosine similarity (distance) score is calculated based on the given content and time T since that content impacted (i.e., weighted) a response. For example, Orange and Orange Zest are strongly related, so the reference score is high. Thus, if the user recently mentioned Orange Zest and/or if language model 204 brought it up, and since it is strongly related to Orange, then that content has a high reference score being that it is important in the reference.

To use an example to illustrate this concept, say for instance, that the reference score SCORE_{REF} is calculated as:

$${SCORE}_{REF} = Cosine Similarity * T ,$$

where the value of T is inversely related to the number of messages exchanged since the content in question (e.g., Oranges) was discussed. As described in detail above, cosine similarity ranges from 0 to 1. Thus, for example, if 100 messages have been exchanged, then the T value may be 100/100=1 for the 1^{st} message exchanged. By the 30^{th} message exchanged, the T value becomes 70/100=0.7. A weak reference (e.g., cosine similarity of 0.4) but recent (T=0.7) would yield a reference score SCORE_{REF} of (0.4)(0.7)=0.28. As will be described in detail below, following the passage of a timing threshold, the reference scores of the prompts and responses will be used to determine whether the content of a cluster is relevant enough to keep it in the thread. Otherwise, the cluster can be a candidate for removal from the thread. This timing threshold may be reflected in the instant example as the value of T being less than a certain value, e.g., 0.5. In that case, the evaluation to remove or maintain a cluster would be made after the exchange of 50 messages (i.e., 50/100=0.5).

Being time-based, a higher reference score means that information related to a particular topic was mentioned recently in the conversation. Conversely, a lower reference score means that a significant amount of time has elapsed since a topic was brought up again, if at all. Accordingly, any reference back to information in a prompt or response will increase its reference score. See step 412. Namely, mentioning this information positively reinforces its importance and relevance to the current conversation. Further, as highlighted above, an autonomous forgetting parameter can also be implemented in addition to the reference score. For instance, upon hearing that the user wants to discuss a topic again later, the thread truncation module 208 will decrease the forgetting parameter for this topic. This forgetting parameter can be used to boost the overall reference value (see below) for the information in the respective cluster. In that case, the cluster will be more likely to remain in the thread following truncation. Conversely, upon hearing that the user is tired of discussing a topic, then the thread truncation module 208 will increase the forgetting parameter for this topic, thereby lowering the overall reference value for the respective cluster. In that case, the cluster may be more likely to be removed from the thread during truncation.

While they both relate to the value of maintaining a cluster in the thread, the reference score looks at topic interest in a slightly different way from the forgetting parameter. Namely, the reference score validates the information clustered around a topic based on the number of recent ‘comebacks’ in the current conversation. On the other hand, if implemented, the forgetting parameter permits the designation of topics (autonomously through the natural flow of the conversation) that are or are not of future interest for discussion.

In step 414, a determination is made by the thread truncation module 208 as to whether the timing threshold has been reached. As highlighted above, this timing threshold can be based on the passage of more than a certain amount of time and/or the exchange of more than a certain number of messages (i.e., prompts and responses). For instance, a timing threshold of greater than 30 minutes and/or the exchange of more than 50 messages following the creation of a given cluster in step 406 (see above) may be used as a non-limiting illustrative example. Further, these timing threshold requirements can be used individually or combined. For example, imposing the timing threshold may invoke the passage of more than the threshold amount of time (e.g., more than 30 minutes has elapsed) or the exchange of more than the threshold number of messages (e.g., more than 50 messages) since the most recent cluster was created, whichever happens first.

If it is determined by the thread truncation module 208 in step 414 that, NO, the timing threshold has not yet been reached meaning that the passage of more than a threshold amount of time and/or the exchange of more than a threshold number of messages has not yet occurred since the given cluster was created in step 406, then the thread truncation module 208 will continue to iteratively process the prompts and responses as the conversation builds (as per step 408), and dynamically generate/increase the respective reference scores (as per steps 410/412).

On the other hand, if it is determined by the thread truncation module 208 in step 414 that, YES, the timing threshold has been reached meaning that more than a threshold amount of time has passed and/or more than a threshold number of messages have been exchanged since the given cluster was created in step 406, then in step 416 a determination is made as to whether the current topic of conversation differs from that of the given cluster. The notion here is that, even if the timing threshold since that cluster was created has been surpassed, its topic may still be relevant to the current discussion. In other words, one would not want to remove a cluster around a topic that is still currently the subject of the conversation, albeit lengthy. Rather, older topics no longer being discussed should be identified for potential removal during truncation.

According to an exemplary embodiment, the difference between the given cluster and the current topic of conversation is quantified based on a distance measure. In machine learning, a distance measure is generally an objective score that signifies the difference between objects in a domain. As provided above, language models represent words using vectors which are unique to each of the words in a text. As such, these vectors can be thought of as representing the meaning of individual words in the text.

A common distance measure such as Euclidean distance is well suited to calculate the distance between such real-valued vectors. Accordingly, in step 416, thread truncation module 208 can simply compare the average distance between the prompts and responses in the given cluster with those of the n-most recent prompts and responses in the conversation. If the distance is greater than a predetermined threshold value, then the topic of the given cluster is deemed to be different from the current topic of conversation. Conversely, if the distance is less than or equal to the predetermined threshold value, then the topic of the given cluster does not differ significantly from the current topic of conversation.

If it is determined by the thread truncation module 208 in step 416 that, NO, the topic of the given cluster does not differ significantly from the current topic of conversation, then in step 418 the given cluster and its associated messages (i.e., prompts and responses) are validated in the thread. This means that the given cluster and its associated messages will not be removed during truncation of the thread.

On the other hand, if it is determined by the thread truncation module 208 in step 416 that, YES, the topic of the given cluster is different from the current topic of conversation, then in step 420 a determination is made by the thread truncation module 208 as to whether an overall reference value of the given cluster is low, i.e., less than a (preset) minimum reference value. As provided above, each cluster contains messages (i.e., prompts and responses) clustered around a topic. Reference scores are individually generated for the prompts and responses in each of the clusters (see step 410 above) which is a time-based metric representing the last time the conversation has come back to (i.e., referenced) information contained in the prompts and responses. These reference scores contribute to the overall reference value of the respective cluster. Thus, at the cluster level, the reference value represents how recently the conversation has come back to information contained in the prompts and responses in the given cluster.

According to an exemplary embodiment, the reference value for a cluster is computed by the thread truncation module 208 as an average value of the reference scores for the prompts and responses in the cluster. It is then determined whether that average value is less than the preset minimum reference value. Alternatively, the highest reference score value amongst the reference scores for the prompts and responses in the cluster might be used as the reference value for the cluster, and that highest reference score value compared against the preset minimum reference value.

Further, another approach contemplated herein is to determine whether at least x percentage of the reference scores for the prompts and responses in the cluster are at or above the preset minimum reference value. If not, then the cluster reference value is considered low, thus making it a more likely candidate for removal during truncation. To illustrate this concept, say for instance that x is preset at 50%, and less than 50% of the reference scores for the prompts and responses in the cluster are at or above the preset minimum reference value. In that case, the reference value for the cluster is considered low.

If it is determined by the thread truncation module 208 in step 420 that, NO, the reference value of the cluster is not low, then as per step 418 above the given cluster and its associated messages (i.e., prompts and responses) are validated in the thread. This means that the given cluster and its associated messages will not be removed during truncation, but rather will be retained in the thread. When the reference value of the cluster is high (i.e., not low) it means that the reference value for the cluster, calculated for example from the reference scores using the metrics above, is greater than or equal to the preset minimum reference value. To look at it another way, reference has been made back to the information in the cluster a sufficient amount of times in the current conversation to justify keeping that information in the thread, as it is likely to still be of interest to the user.

On the other hand, if it is determined by the thread truncation module 208 in step 420 that, YES, the reference value of the cluster is low, then in step 422 the thread truncation module 208 removes the cluster and its associated messages (i.e., the prompts and responses in the cluster) from the thread thereby truncating the thread. When the reference value of the cluster is low it means that the reference value for the cluster, calculated for example from the reference scores using the metrics above, is less than the preset minimum reference value. To look at it another way, reference has not been made back to the information in the cluster a sufficient amount of times in the current conversation to justify keeping that information in the thread, as it is likely no longer of interest to the user.

It is also at this point in the process where the above-described autonomous forgetting parameter can come into consideration. For instance, when evaluating the reference value of the cluster in step 420, the thread truncation module 208 might also take into account statements the user made in the course of the conversation indicating, for example, whether the user would like to discuss something further. For instance, even if the current topic of conversation is different from that of the cluster (step 416) and the reference value of the cluster is low (step 420), the thread truncation module 208 may still retain the cluster in the thread (step 418) if the user has stated that the user would like to revisit the topic of the cluster at a later time. Conversely, even if the current topic of conversation does not differ from that of the cluster (step 416) and the reference value of the cluster is not low (step 420), the thread truncation module 208 may still remove the cluster from the thread (step 418) if the user has stated that the user is tired of discussing the topic of the cluster.

By way of this intelligent selection process, older topics can be cleared from long-running threads making the processed threads easier for the user to follow, and more focused on the topics the user wishes to discuss. For instance, suppose the conversation included an initial discussion about orange juice making around which the given cluster was created in step 406. However, suppose 50 messages later there has been no further mention of this topic, and in fact the conversation has shifted to the topic of vacation destinations. After reaching the timing threshold in step 414, the cluster created in step 406 may be a good candidate for removal from the thread since it differs from the current topic of conversation, i.e., vacation destinations (as evaluated in step 416) and has a low reference value due to a lack of ‘comebacks’ to the topic of orange juice making (as evaluated in step 420). Even further, if the user says something like “Seems like juice making requires tools I don't have, so I don't want to discuss this further” (an autonomous forgetting parameter signifier), then thread truncation module 208 may go ahead and remove that cluster and all of its associated messages from the thread. Conversely, if the user instead mentions that “juice making is of great interest to me, so I would like to talk about it again later,” then thread truncation module 208 may retain the cluster created in step 406 in the thread.

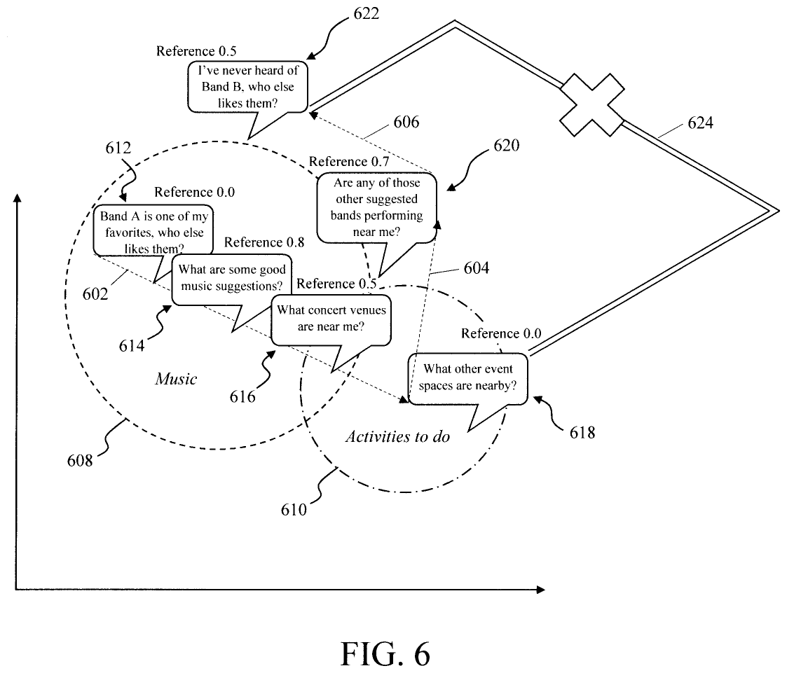

The present techniques are further described by way of reference to the following non-limiting examples. Referring to FIG. 6, an exemplary thread of user interactions with the language model 204 during a conversation are depicted. For ease and clarity of depiction, only a representative sampling of the messages exchanged is shown. The progression of the conversation is indicated by arrows 602, 604 and 606, which collectively form a conversation thread. Namely, as indicated by arrow 602, the conversation begins with prompts by the user clustered around the topic of Music. See cluster 608 labeled “Music.”

For instance, the user begins with “Band A is one of my favorites, who else likes them?” (see prompt 612), followed by “What are some good music suggestions?” (see prompt 614), and “What concert venues are near me?” (see prompt 616). In the same manner as described in conjunction with the description of methodology 400 of FIG. 4 above, once the user opts into the present autotruncation feature (step 402), the thread truncation module 208 will obtain the messages exchanged between the user and the language model 204, including these prompts 612-616 (step 404).

The thread truncation module 208 will then cluster the messages (i.e., prompts and responses) based on their topical representation, thereby creating a cluster such as cluster 608 around a topic, in this case the topic of Music (step 406). Namely, each of the prompts 612-616 contains words related to the topic of Music, such as ‘Band,’ ‘music,’ and ‘concert’ (see prompts 612, 614 and 616, respectively). Notably, prompt 616 begins to shift the conversation as it also mentions ‘venues,’ i.e., for activities like ‘concerts’ or otherwise.

Thread truncation module 208 will continue to process the prompts and responses in an iterative manner as the conversation continues (step 408). Thus, as more prompts are obtained such as “What other event spaces are nearby?” (see prompt 618), the thread truncation module 208 will add them to an existing cluster or, as in this case, create a new cluster around a newly discussed topic. See cluster 610 around the topic of activities to do. As highlighted above, messages such as prompt 616 can contain information related to multiple topics, in this case ‘concert’/Music and ‘venues’/Activities to do. Thus, clusters 608 and 610 can overlap one another.

A reference score is shown above each of the prompts. For instance, prompt 612 has a reference score 0.0, prompt 614 has a reference score 0.8, and so on. As described above, thread truncation module 208 calculates these reference scores (step 410) based on the last time the conversation has come back to (i.e., referenced) information contained in the given prompt or response. For example, outside of prompt 612, no further reference is made to ‘Band A’ in the conversation. Thus, prompt 612 is given the (lowest) reference score of 0.0. By contrast, reference back to ‘music’ and ‘suggestions’ in multiple other prompts (e.g., prompts 620 and 622 described below) gives prompt 614 a reference score of 0.8. As such, any reference back to information in a prompt or response will increase its reference score (step 412).

As also described above, the individual reference scores of the prompts and responses in a cluster are collectively used to determine a reference value for the cluster. In other words, the reference value for the cluster represents how recently the conversation has come back to the information contained in the prompts and responses in the cluster. For instance, the reference value for a cluster can be computed as an average value of the reference scores for the prompts and responses in the cluster. Taking prompts 612, 614 and 616 as an illustrative example, the average of their reference scores 0.0, 0.8 and 0.5, respectively, can be used to determine a reference value of 0.4 for cluster 608. Similarly, the average of the reference scores 0.5 and 0.0 of prompts 616 and 618, respectively, can be used to determine a reference value of 0.3 for cluster 608.

Alternatively, the highest reference score value amongst the reference scores for the prompts and responses in the cluster might be used as the reference value for the cluster. For example, the reference score of 0.8 for prompt 614 is the highest in cluster 608. As such, 0.8 may be used as the reference value for cluster 608. Similarly, the reference score of 0.5 is the highest in cluster 610, and thus may be used as the reference value for cluster 610.

Yet further, the individual reference scores of the prompts and responses in a cluster can be collectively examined to see whether at least x percentage of their reference scores are at or above a minimum reference value that, according to an exemplary embodiment, can be preset and adjusted by the user. For instance, referring to the example in FIG. 6, if x is 50% and the minimum reference value is preset at 0.5, then cluster 608 has at least 50% of its corresponding reference scores at or above the minimum reference value (since all prompts other than prompt 612 in cluster 608 have reference scores above the minimum reference value). Cluster 610 also has at least 50% of its corresponding reference scores at or above the minimum reference value (i.e., based on the reference scores 0.5 and 0.0 for prompts 616 and 618, respectively).

As indicated by arrow 604, the conversation then shifts from a discussion of event spaces back to the topic of Music with “Are there any of those other suggested bands performing near me?” (see prompt 620) and “I've never heard of Band B, who else likes them?” (see prompt 622). As highlighted above, these new prompts in the conversation will be obtained by the thread truncation module 208, processed and, in this case, added to cluster 608 based on their topical representation. Notably, prompt 620 has a reference score of 0.7 and prompt 622 has a reference score of 0.5 which, based on the approaches described above, will impact the reference value of the cluster 608 to which they are added.

Say then, for example, that the timing threshold has been reached (step 414) based on the passage of more than a threshold amount of time (e.g., more than 30 minutes) and/or the exchange of more than a threshold number of messages (e.g., more than 50 messages) since the cluster 610 was created (as per step 406). Also, because the conversation has shifted back to the topic of Music, and away from a discussion of Activities to do which is the topic of cluster 610, it is determined that the topic of cluster 610 is different from the current topic of conversation. This topical difference is depicted graphically by line 624. Further, assume that cluster 610 has a low reference value, meaning that the reference value of cluster 610 is less than a minimum reference value. In that case, thread truncation module 208 can remove cluster 610 from the conversation thread (step 422). Truncating the conversation thread in this manner involves removing prompt 618 from the conversation thread. Since prompt 616 is also a part of cluster 608, it will remain in the conversation thread. Although not shown, if instead the reference value of cluster 610 was at or above the minimum reference value and/or the user had expressed a desire to revisit the topic of Activities to do (thereby lowering the autonomous forgetting parameter), then thread truncation module 208 would instead retain prompt 618 in the conversation thread.

As highlighted above, the autonomous forgetting parameter can be decreased or increased based on changes to the subject matter and protocol usages. For instance, as the user starts asking the language model 204 to remember the various items that were referenced within the earlier part of the conversation, thread truncation module 208 must decrease the forgetting parameter, so that the language model 204 can autonomously consider more based on subject matter changes and ameliorations that the user is defining within the subject matter changing and building over time. This would allow for a preservation of various subject matter to be preserved while the conversation continues to develop. The user might say something such as “Just like the music scene in city X, I want to talk about the new music scene in city Y.” Thus, the user is autonomously decreasing the divergent parameter here within the scenario above.

By contrast, since the conversation will develop naturally over time, breaking points can be established through natural language processing where the user issues a commend to remove a previous part or parts of the conversation which would be based on specific commands (or command-like) protocols from the user. For instance, say the user was talking about the music scene in city X and wants to clearly reference that within the ever-building conversation about bands and singers. Then, suddenly the user makes a statement specific to the conversation bot 202, like “Never mind, I don't want to use or talk about the music scene in city X and singers anymore, but let's consider the music scene in city Y.” In that case, the user is autonomously increasing the divergent parameter within the scenario above.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A language model thread truncation system, comprising:
a language model; and
a thread truncation module configured to obtain prompts and responses from a thread of user interactions with the language model during a conversation, cluster the prompts and responses based on their topical representation to create a cluster around a topic, and after a timing threshold for the cluster has been reached, truncate the thread by removing the cluster from the thread if the current topic of the conversation differs from the topic of the cluster and if a reference value of the cluster is below a minimum value, otherwise retain the cluster in the thread.

2. The language model thread truncation system of claim 1, wherein the reference value of the cluster represents how recently the conversation has come back to information contained in the prompts and response in the cluster.

3. The language model thread truncation system of claim 1, wherein the thread truncation module is further configured to obtain new prompts and responses as the conversation continues, and add the new prompts and response to the cluster or to another cluster.

4. The language model thread truncation system of claim 1, wherein the prompts and responses are clustered using cosine similarity or latent Dirichlet allocation.

5. The language model thread truncation system of claim 1, wherein reference is made in the conversation to the information contained in a given prompt or response, and wherein the thread truncation module is further configured to increase the individual reference score for the given prompt or response.

6. The language model thread truncation system of claim 1, wherein the timing threshold comprises a passage of more than a certain amount of time since the cluster was created.

7. The language model thread truncation system of claim 1, wherein the prompts and responses comprise messages in the thread, and wherein the timing threshold comprises an exchange of more than a certain number of messages since the cluster was created.

8. The language model thread truncation system of claim 1, wherein to remove the cluster from the thread, the thread truncation module is configured to remove the prompts and responses from the thread that were used to create the cluster.

9. The language model thread truncation system of claim 1, wherein to retain the cluster in the thread, the thread truncation module is configured to retain the prompts and responses in the thread that were used to create the cluster.

10. A language model thread truncation system, comprising:
a language model; and
a thread truncation module configured to obtain prompts and responses from a thread of user interactions with the language model during a conversation, cluster the prompts and responses based on their topical representation to create a cluster around a topic, generate individual reference scores for the prompts and responses in the cluster, wherein the individual reference scores represent a last time the conversation has comes back to information contained in the prompts and responses, and after a timing threshold for the cluster has been reached, truncate the thread by removing the cluster from the thread if the current topic of the conversation differs from the topic of the cluster and if a reference value of the cluster is below a minimum reference value, otherwise retain the cluster in the thread,
wherein the reference value of the cluster is determined based on the individual reference scores for the prompts and responses in the cluster.

11. The language model thread truncation system of claim 10, wherein the reference value of the cluster is determined as an average value of the individual reference scores for the prompts and responses in the cluster.

12. The language model thread truncation system of claim 10, wherein a highest reference score value amongst the individual reference scores for the prompts and responses in the cluster is used as the reference value of the cluster.

13. A method for language model thread truncation, comprising:
obtaining prompts and responses from a thread of user interactions with a language model during a conversation;
clustering the prompts and responses based on their topical representation to create a cluster around a topic;
generating individual reference scores for the prompts and responses in the cluster, wherein the reference scores represent a last time the conversation has come back to information contained in the prompts and responses; and
after a timing threshold for the cluster has been reached, truncating the thread by removing the cluster from the thread if the current topic of the conversation differs from the topic of the cluster and if a reference value of the cluster is below a minimum value, otherwise retaining the cluster in the thread, wherein the reference value of the cluster is determined based on the individual reference scores for the prompts and responses in the cluster.

14. The method of claim 13, further comprising:
obtaining new prompts and responses as the conversation continues; and
adding the new prompts and response to the cluster or to another cluster.

15. The method of claim 13, wherein the clustering is performed using cosine similarity or latent Dirichlet allocation.

16. The method of claim 13, wherein reference is made in the conversation to the information contained in a given prompt or response, and wherein the method further comprises:
increasing the individual reference score for the given prompt or response.

17. The method of claim 13, wherein the prompts and responses comprise messages in the thread, and wherein the timing threshold is selected from the group consisting of: a passage of more than a certain amount of time since the cluster was created, an exchange of more than a certain number of messages since the cluster was created, or combinations thereof.

18. The method of claim 13, wherein the reference value of the cluster is determined as an average value of the individual reference scores for the prompts and responses in the cluster.

19. The method of claim 13, wherein a highest reference score value amongst the individual reference scores for the prompts and responses in the cluster is used as the reference value of the cluster.

20. The method of claim 13, wherein removing the cluster from the thread comprises:
removing the prompts and responses from the thread that were used to create the cluster.
